(19) United States
(12) Patent Application Publication
(10) Pub. No.: US 2004/0215765 A1
(43) Pub. Date: Oct. 28, 2004

(54) Method for integrated infrastructure and facility management

(76) Inventors: Michael L. Asher, Green Grove Springs, FL (US); Hossein Eslambolchi, Los Altos Hills, CA (US); Charles C. Giddens, Conyers, GA (US); Jacquenetta M. Mason, Duluth, GA (US); Prakash Rangavittal, Alpharetta, GA (US); Harold Jeffrey Stewart, Alpharetta, GA (US)

Correspondence Address: AT&T CORP., P.O. BOX 4110, MIDDLETOWN, NJ, 07748, US

(21) Appl. No.: 10/423,417

(22) Filed: Apr. 25, 2003

(51) Int. Cl. G06F 15/173

(52) U.S. Cl. 709/224

(57) ABSTRACT

In accordance with the teachings of the present invention, a method of providing relevant information about a network problem is presented. In one embodiment of the present invention, methods are presented for acquiring, analyzing, and distributing relevant information to network operations personnel, which include both service provider personnel and clients. A network portal is presented. The network portal consolidates and intelligently distributes network operations information, such as alarm information in real time. As such, the information required to make informed decisions is communicated to network operations personnel in a format that facilitates the access and use of the information. In addition, as the network problem changes (i.e., resolves, escalates), the changes in the alarm information may also be communicated to network operations personnel.

### BACKGROUND OF THE INVENTION

1. Field of the Invention

This invention relates to information management. Specifically, the present invention relates to information processing and notification.

2. Description of the Prior Art

Modern businesses rely on communications. Whether the business is a multi-national corporation or a service provider, communications between company members is essential. Further, without communications it would be impractical to operate most businesses.

Communications infrastructure is the vehicle that facilitates business communications. As a result, a company's communications infrastructure is often considered an important component of a company's strategy. Therefore, the operations and maintenance of communications infrastructure is critical.

Specifically, when the company is a service provider and communications is the core business, operating and maintaining the communications infrastructure to provide service is the company's top priority. Therefore, a large variety of techniques have been developed for operating communications networks and providing service to clients.

However, as communications networks become larger, more diverse, and more complex, maintaining communications infrastructure can be challenging. For example, should a network problem occur, such as a failed component, network congestion, a cable cut, equipment overheating, or any condition that will lead to poor operations in a network, it is important to make the network operations team as well as the client whose service may be interrupted aware of the network problem.

However, in conventional networks, adequate systems and processes are not in place to facilitate real-time information flow between members of the network operations team. In addition, there is often no way of alerting a client of the network problem. In some instances, the client is the first to know about a network problem and the client contacts the service provider. Without information flow between members of the network operations team, any attempts to resolve the network problem may be disconnected and/or counterproductive. For example, various members of the network operations team may each attempt to resolve the network problem without being aware of what the other members of the team are doing to resolve the network problem. Lastly, the clients may be left without service or a way of knowing when service will be returned.

Thus, there is a need for a method of exchanging information about network operations (i.e., such as network problems) among various members of a network operations team. There is a need for a method of coordinating the resolution of a network problem among various members of a network operations team. Lastly, there is a need for a method of contacting and updating a client about network problems and their resolution.

### SUMMARY OF THE INVENTION

A method is presented for facilitating information flow among network operations personnel to resolve network problems. Network operations personnel, such as network operators, building engineers, technicians, network operation center technicians, problem management office personnel, service provider management staff, are notified of network problems using the teachings of the present invention. In addition, clients are also notified using the teachings of the present invention.

Alarm information is coordinated and correlated where necessary so that when each member of the network operations team or a client receives the alarm information, they are provided with relevant real-time information that they can use to make informed decisions and properly address the network problem. The alarm information is coordinated and correlated using a variety of methods to automatically access and acquire alarm information and present relevant information to members of the network operations team in real time. For example, in one embodiment of the present invention, building engineers, network operation center engineers, problem management office personnel, service provider management, and clients are each provided with relevant information about a network problem in real time.

A method of integrating network information, the method comprises the steps of operating a network portal in communication with a communication network, the network portal implementing Web Services and capable of invoking a plurality of methods directed at communicating alarm information to a plurality of end users; and transmitting the alarm information to at least one of the plurality of end users in response to invoking the plurality of methods directed at communicating the alarm information.

A method of processing information comprises the steps of invoking an alarm method, the alarm method acquiring first alarm information identifying a network problem in a communication network; invoking a follow-me method, the follow-me method accessing presence information and transmitting second alarm information to a network operator in response to the presence information and in response to the first alarm information; invoking a CAD method, the CAD method accessing CAD information and transmitting the CAD information to a network operator in response to the first alarm information; invoking a management method, the management method associating management with the first alarm information and transmitting third alarm information to the management in response to the first alarm information; invoking a client method, the client method identifying clients impacted by the network problem and transmitting fourth alarm information to the clients in response to the first alarm information; invoking a historical trending method, the historical trending method performing historical trending in response to the first alarm information; and invoking a display method, the display method transmitting display information that causes a device to display the network problem in response to the first alarm information.

A method of processing information comprises the steps of invoking an alarm method, the alarm method acquiring first alarm information identifying a network problem in a communication network; invoking a follow-me method, the follow-me method accessing presence information and transmitting second alarm information to a network operations center in response to the presence information and in response to the first alarm information; invoking an impact method, the impact method transmitting impact information to a network operator in response to the first alarm information, the impact information describing additional impact of the network problem; invoking a management method, the management method associating management with the network problem and transmitting third alarm information to the management; invoking a client method, the client method identifying clients impacted by the network problem and transmitting fourth alarm information to the clients; and invoking a display method, the display method transmitting display information that causes a device to display the network problem.

### BRIEF DESCRIPTION OF THE DRAWINGS

FIG. 1 displays an information flow diagram implemented in accordance with the teachings of the present invention.

FIG. 2 displays an alternate embodiment of an information flow diagram implemented in accordance with the teachings of the present invention.

FIG. 3 displays a block diagram of a computer implemented in accordance with the teachings of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

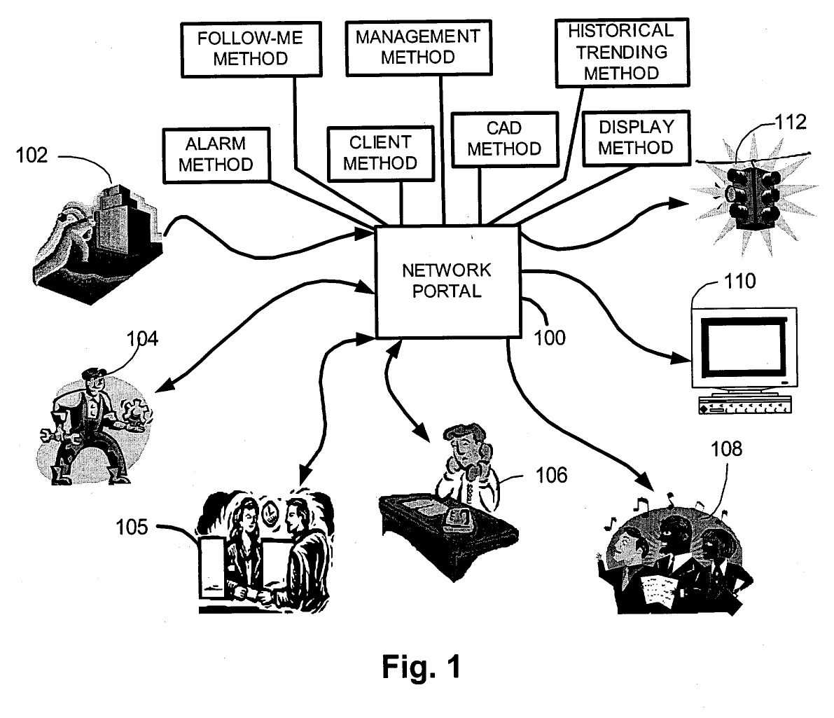

A method for providing timely, relevant information to network operations personnel and clients is presented. Relevant information is information required or desired by personnel to perform their respective duties. A network portal is presented. The network portal consolidates and processes information generated from network problems. The network portal implements a variety of intelligent interactive methods which enable the network portal to find relevant information, to change information, and to update operations personnel during the resolution process. Further, the network portal 100 shown in FIG. 1 includes methods to escalate a problem if the current resolution does not work. The network portal 100 may be implemented as a centralized architecture or a distributed architecture; or as systems continue to miniaturize, the functionality of the network portal 100 may be implemented on a single interface card or on a single semiconductor device.

In one embodiment of the present invention, the network portal 100 may invoke an alarm method, a follow-me method, a Computer Aided Design (CAD) method, a management/problem management office method, a display method, a historical trending method, and an impact method.

It should be appreciated that each of these methods may be implemented as hardware, software, or a combination of hardware and software. Further, it should be appreciated that each of these methods may be implemented on a centralized architecture, such as the network portal 100. Alternatively, each method may be implemented in a separate computer which is in communication with a network portal 100, which provides centralized operations.

In one embodiment of the present invention, the network portal 100 is a device capable of communicating across the Internet (i.e., a web-enabled device), such as a computer running a web browser. In addition, each of the methods may be implemented in a computer communicating across the Internet using Internet-compliant protocols, such as Transmission Control Protocol/Internet Protocol (TCP/IP) and Extensible Markup Language (XML). As such, each method may be invoked through a web browser across the Internet.

Invoking a method may involve initiating and performing a method on the network portal 100. Further, invoking a method may involve initiating a method on the network portal 100 that performs a method on a separate machine. Lastly, invoking a method may involve a combination of performing methods on the network portal 100 and on other machines.

In one embodiment of the present invention, the network portal 100 is implemented in a centralized architecture. In a centralized architecture, the network portal 100 performs the alarm method, the follow-me method, the Computer Aided Design (CAD) method, the management/problem management office method, the display method, the historical trending method, and the impact method. In an alternative embodiment of the present invention, the network portal 100 is implemented as a distributed architecture and the alarm method, the follow-me method, the Computer Aided Design (CAD) method, the management/problem management office method, the display method, the historical trending method, and the impact method are each performed by a separate computer. Lastly, it should be appreciated that a combination of the two embodiments, with some methods performed on the network portal 100 and some methods performed by other computers, may be implemented and still remain within the scope of the present invention.

In one embodiment of the present invention, the network portal 100 is implemented with Web Services as defined by the World Wide Web Consortium (W3C). For example, the W3C defines web service as a software system identified by a universal identifier, whose public interfaces and bindings are defined and described using Extensible Markup Lanaguage (XML). The definition of the software system can be discovered by other software systems. These systems may then interact with the web service in a manner prescribed by its definition, using XML-based messages conveyed by Internet protocols.

In one embodiment of the present invention, Web Services, as described in W3C Working Draft 14 Nov. 2002 (w3.org/TR/2002/WD-ws-arch-20021114), are implemented. Web Services are promulgated in the World Wide Web Consortium (W3C), where Web Services are defined as the programmatic interfaces used for application-to-application communication over the web. Web Services provide a standard means of communication among different software applications, running on a variety of platforms and/or frameworks. Web Services are typically implemented with Extensible Markup Language (XML) based standards, such as Simple Object Access Protocol (SOAP), as described in SOAP Version 1.2 Part 1: MessagingFramework W3C Candidate Recommendation 19 Dec. 2002 (w3.org/TR/soap12-part1l/); Web Services Description Language (WSDL), as described in Web Services Description Language (WSDL) Version 1.2 W3C Working Draft 24 Jan. 2003 (w3.org/TR/wsdl12/); Universal Description Descovery and Integration Web Services (UDDI), as described in Version 3.0 Published Specification, 19 Jul. 2002 (uddi.org/pubs/uddi-v3.00-published-20020719.htm).

The network portal 100 may be implemented in a server, which invokes methods operating in other computers communicating across a communications network. For example, the network portal 100 may implement Extensible Markup Language (XML), Universal Description Discovery and Integration (UDDI), Simple object Access Protocol (SOAP), Web Service Description Language (WSDL), Hypertext Transport Protocol (HTTP), or Remote Procedure Calls (RPC) to invoke methods that process and communicate alarm information to network operations personnel. It should be appreciated that selected components of the Web Services architecture may be implemented and still remain within the scope of the present invention. It is fully anticipated that the various Web Services standards will continue to advance; however, a web service implementation as defined above is within the scope of the present invention. For example, SOAP version 1.2 and WSDL version 1.2 are currently being deployed. However, it is fully expected that the W3C will continue to advance these standards. As such, the teachings of the present invention are not directed to a specific version of the various standards, but at the underlying Web Services definition as described above. It should also be noted that the Web Services definition does not presuppose the implementation of UDDI, SOAP, or WSDL.

In another embodiment of the present invention, the network portal 100 may invoke methods without Web Services to initiate methods on other computers. For example, the network portal 100 may be implemented in a server and initiate methods, such as the alarm method, the follow-me method, the CAD method, the management method, the client method, the historical trending method, the display method, and the impact method.

The alarm method is used to acquire alarm information resulting from a network problem. The alarm method includes processes that receive alarm information communicated from network locations or processes that poll network locations to acquire alarm information. The alarm information may be any information that indicates a network problem. The follow-me method includes processes that locate network operations personnel at a predefined location. The follow-me method accesses a presence database, which provides a predefined location and device that the network operations personnel should be contacted on. The CAD method includes processes that access CAD drawings and communicate the drawings to network operations personnel (i.e., directly or through the network portal 100). The management method includes procedures that associate network circuits and infrastructure with the service provider management personnel responsible for the network affected by a network problem. The client method includes procedures that identify and/or communicate with clients that are affected by the network problem. The historical trending method includes procedures that enable historical analysis of network problems. Lastly, the display method includes procedures used to display information on a display device, such as a large wall monitor in a network operations center. The display method controls the display of alarms on the display and the removal of alarms from the display.

During operations, an alarm (i.e., alarm information) is generated at the network location (i.e., building) 102. The alarm is generated as a result of a network problem, such as a power outage, network congestion, cable cut, overheating in a room, or any problem that impacts the network. The alarm method is invoked by the network portal 100 to acquire the alarm information. The alarm information may be acquired by receiving information communicated to the network portal 100 or the network portal 100 may poll the network location 102 to acquire the alarm information. The alarm information may include a variety of information, such as the location of the alarm, the type of alarm, the equipment generating the alarm, client information, etc.

Relevant alarm information is communicated to network operations personnel 104. The follow-me method is invoked by the network portal 100 to contact network operations personnel 104 (i.e., an engineer, technician, or other personnel). Alarm information relevant to the network operations personnel 104 is then communicated. As such, alarm information (i.e., network operations personnel alarm information) that enables the network operations personnel 104 to make judgments relevant to their duties is communicated. For example, the location of the alarm and the severity of the alarm may be communicated to the network operations personnel 104. The network operations personnel 104 may then determine whether a specific technician should be dispatched.

CAD information is communicated to network operations center personnel 105. The network portal 100 invokes the CAD method to retrieve CAD information of the alarm location (i.e., building 102). The CAD information of the alarm location is identified using a key, such as a location key, provided in the alarm information. The CAD Method is then used by the network portal 100 to forward the CAD information (i.e., drawings) to the network operations personnel 104 or to a separate network operations center for display and review by additional network operations center personnel 105.

Relevant alarm information is communicated to management/help desk personnel 106. The network portal 100 invokes a management/help desk method. The management/help desk method determines the management 106 responsible for the alarm location and communicates relevant alarm information (i.e., personnel responsible, affected client, estimated number of technician required, etc.) to the management personnel. As such, the management 106 may devise a strategic course of action and deploy the appropriate resources to resolve the problem and perform customer relation, if necessary. In addition, the help desk process is used to alert management/help desk personnel 106 of the problem so that customer inquiries may be properly addressed. Therefore, relevant alarm information, such as predefined scripts and details about the alarm, may be communicated so that the management/help desk personnel 106 can adequately respond to any questions.

Relevant alarm information is communicated to the client 108. The network portal 100 invokes a client method. The client method uses the alarm information to identify the circuit and equipment that is affected by the network problem. As such, clients 108 may be notified of the network problem. In addition, relevant alarm information may be transmitted to the client 108, such as the estimated time to resolve the network problem, the location of the network problem, the client facilities affected by the network problem, etc.

Historical trending is performed. The network portal 100 invokes a historical trending method. The network operations center personnel 105, the management/help desk personnel 106, or any service provider personnel may run the historical trending method. For example, the historical trending method may be invoked through a network browser 110 to provide historical trend analysis of the network problem. As such, the network problem may be isolated and resolved based on historical information. In one embodiment of the present invention, the web browser 110 is used to invoke the historical trending method.

Alarm information is communicated to a display device 112. A display method is invoked by the network portal 100 to display the network problem on a display device 112, such as a large wall screen in a network operations center. In addition to displaying the alarm, the display method may also be used to remove the alarm once the problem has been resolved. Using the large display device 112, a number of different personnel in the network operations center may view the alarm and cooperatively work to resolve the problem.

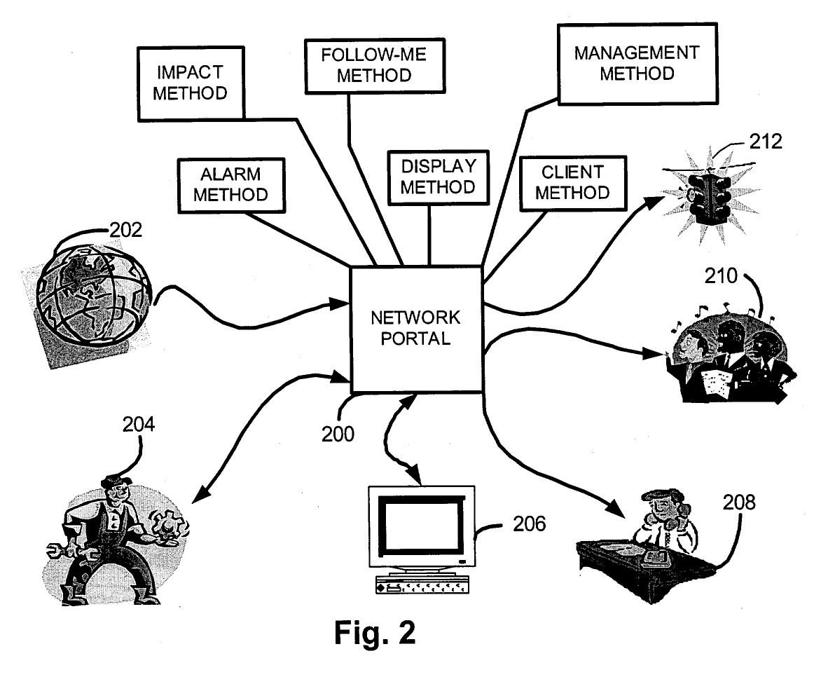

FIG. 2 displays an alternative embodiment of an information flow method implemented in accordance with the teachings of the present invention. In the alternative method displayed in FIG. 2, a network portal 200 manages and processes the flow of network operations information, such as alarm information. The network portal 200 implements a variety of processes to accomplish this objective. For example, in one embodiment of the present invention, the network portal 200 invokes alarm methods, impact methods, follow-me methods, CAD methods, display methods, client methods, and management/help desk methods.

Alarm information is received in the network operations center 202 and displayed on a map of the network. The alarm information represents an alarm. The alarm may disclose the failure of a T1, T2, T3, STS, Ocx connection, cable cut, power outage, or some other type of network problem. The network portal 200 acquires the alarm information and processes (i.e., analyzes, parses, etc.) the alarm information prior to distribution.

Relevant alarm information (i.e., alarm information required by the network operations personnel 204) is then communicated to network operations personnel 204 responsible for the alarm location. The network portal 200 may use a follow-me method to communicate the alarm information to network operations personnel 204 at the appropriate contact location.

The network portal 200 performs an impact method. The impact method analyzes the alarm information and determines the impact of the alarm on the network. The impact method may determine the additional circuits, locations, equipment, etc. that may be affected by the network problem. For example, if the alarm information signals a high temperature in a room and one device has failed, the impact process may access a database identifying the other equipment in the heated room, determine the amount of time before the additional equipment fails, and determine the associated circuits that will be affected once the equipment fails.

In one embodiment of the present invention, the impact method accesses CAD information and communicates CAD information of the alarm location with a potential change configuration. For example, if a specific router is failing, the impact method may locate an alternative router that may be used to restore service. As such, a technician can arrive at the alarm location armed with the relevant information required to quickly restore service. Lastly, the impact method may communicate the impact information (i.e., affected infrastructure, CAD information, change configuration information, etc.) to the network operations personnel. In one embodiment of the present invention, the network portal 200 sends a Universal Resource Locator (URL) or an email to a web browser 206 so that the network operations personnel 204 can access the impact information.

Relevant alarm information is communicated to management/help desk personnel 208. The network portal 100 invokes a management method to identify responsible management/help desk personnel 208 and, in conjunction with the follow-me method, contact the appropriate management/help desk personnel 208. Further, the management method may be used to contact and provide the appropriate information to management/help desk personnel 208.

Relevant alarm information is communicated to a client contact 210. A client method is used to query the alarm location for affected cables, router ports, etc. As such, impacted circuits can be identified and then the client contact 210 using the circuits may be identified. The Internet Protocol address or telephone number of the client contact 210 may be identified and messages may be sent to the client contact 210. For example, email may be communicated to the client contact 210 through a computer or cellular telephone, etc. Further, the client method may be used in conjunction with the follow-me method to locate the client contact 210 at a current location and on the appropriate communications device.

Alarm information is communicated to a display 212. The network portal 200 uses a display method to display the alarm on a large display 212. The display method uses the alarm information, such as location information, severity of the alarm, and the type of alarm to display and remove alarm information from a display device. The display method may display the alarm information in a variety of formats, such as text, images, moving images, CAD drawings, etc.

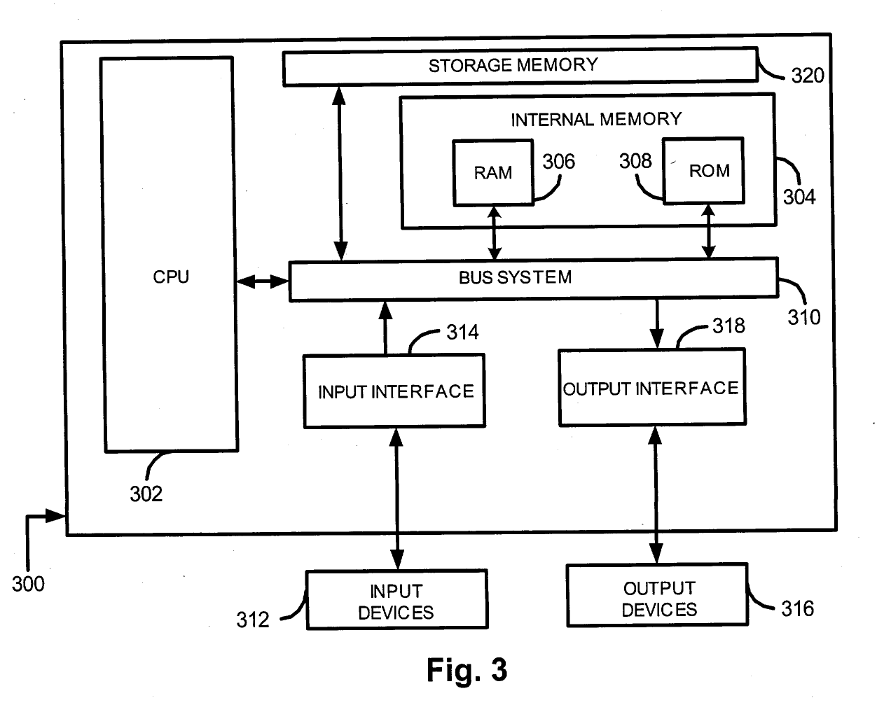

In FIG. 3, a block diagram of a computer 300 is shown. The network portal 100 of FIG. 1, in addition to each of the processes, may be run on a computer. For example, network portal 100 may be run in a server computer, and the alarm method, the follow-me method, the CAD method, the management method, the client method, the display method, the historical method, and the impact method may each operate on computers 300 in communication with the network portal 100.

A central processing unit (CPU) 302 functions as the brain of the computer 300. Internal memory 304 is shown. The internal memory 304 includes short-term memory 306 and long-term memory 308. The short-term memory 306 may be a Random Access Memory (RAM) or a memory cache used for staging information. The long-term memory 308 may be a Read Only Memory (ROM) or an alternative form of memory used for storing information. Storage memory 320 may be any memory residing within the computer 300 other than internal memory 304. In one embodiment of the present invention, storage memory 320 is implemented with a hard drive. A bus system 310 is used to communicate information within computer 300. In addition, the bus system 310 may be connected to interfaces 318 and 314 which communicate information out of the computer 300 or receive information into the computer 300, respectively.

Input devices, such as tactile input device, joystick, keyboards, microphone, communications connections, or a mouse, are shown as 312. The input devices 312 interface with the system through an input interface 314. Output devices, such as a monitor, speakers, communications connections, etc., are shown as 316. The output devices 316 communicate with computer 300 through an output interface 318.

In one embodiment of the present invention, methods are implemented to facilitate the communication of alarm information. The methods may be implemented in software or hardware. For example, a method may be implemented in software and stored in storage memory 320 or RAM 306. Further, a method may be coded in hardware and stored in ROM 308.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

It is, therefore, intended by the appended claims to cover any and all such applications, modifications, and embodiments within the scope of the present invention.

What is claimed is:

1. A method of integrating network information, the method comprising the steps of:
operating a network portal in communication with a communication network, the network portal implementing Web Services and capable of invoking a plurality of methods directed at communicating alarm information to a plurality of end users; and
transmitting the alarm information to at least one of the plurality of end users in response to invoking the plurality of methods directed at communicating the alarm information.

2. A method of integrating network information as set forth in claim 1, wherein each of the plurality of end users receives relevant information.

3. A method of integrating network information as set forth in claim 1, wherein each of the plurality of methods is implemented on a separate computer.

4. A method of integrating network information as set forth in claim 1, wherein the network portal is a web-enabled device and the communication network is the Internet.

5. A method of integrating network information as set forth in claim 1, wherein the Web Services are implemented with Simple Object Application Protocol.

6. A method of integrating network information as set forth in claim 1, wherein the Web Services are implemented with Web Services Description Language.

7. A method of integrating network information as set forth in claim 1, wherein the Web Services are implemented with Hypertext Transfer Protocol.

8. A method of integrating network information as set forth in claim 1, wherein the Web Services are implemented with Remote Procedure Calls.

9. A method of integrating network information as set forth in claim 1, wherein at least one of the plurality of end users is a client contact.

10. A method of integrating network information as set forth in claim 1, wherein at least one of the plurality of methods includes an alarm method for acquiring alarm information.

11. A method of integrating network information as set forth in claim 1, wherein at least one of the plurality of methods includes a follow-me method for identifying at least one of the plurality of end users and transmitting alarm information to the at least one of the plurality of end users.

12. A method of integrating network information as set forth in claim 1, wherein at least one of the plurality of methods includes a CAD method for accessing and transmitting CAD information.

13. A method of integrating network information as set forth in claim 1, wherein at least one of the plurality of methods includes a management method for identifying and transmitting the alarm information to management.

14. A method of integrating network information as set forth in claim 1, wherein at least one of the plurality of methods includes a client method for identifying and transmitting the alarm information to impacted clients.

15. A method of integrating network information as set forth in claim 1, wherein at least one of the plurality of methods includes a historical trending method for performing historical trending analysis.

16. A method of processing information comprising the steps of:
invoking an alarm method, the alarm method acquiring first alarm information identifying a network problem in a communication network;
invoking a follow-me method, the follow-me method accessing presence information and transmitting second alarm information to a network operator in response to the presence information and in response to the first alarm information;
invoking a CAD method, the CAD method accessing CAD information and transmitting the CAD information to a network operator in response to the first alarm information;
invoking a management method, the management method associating management with the first alarm information and transmitting third alarm information to the management in response to the first alarm information;
invoking a client method, the client method identifying clients impacted by the network problem and transmitting fourth alarm information to the clients in response to the first alarm information;
invoking a historical trending method, the historical trending method performing historical trending in response to the first alarm information; and
invoking a display method, the display method transmitting display information that causes a device to display the network problem in response to the first alarm information.

17. A method of processing information as set forth in claim 16, wherein the second alarm information, the third alarm information, and the fourth alarm information are relevant information.

18. A method of processing information comprising the steps of:
invoking an alarm method, the alarm method acquiring first alarm information identifying a network problem in a communication network;
invoking a follow-me method, the follow-me method accessing presence information and transmitting second alarm information to a network operations center in response to the presence information and in response to the first alarm information;
invoking an impact method, the impact method transmitting impact information to a network operator in response to the first alarm information, the impact information describing additional impact of the network problem;
invoking a management method, the management method associating management with the network problem and transmitting third alarm information to the management;
invoking a client method, the client method identifying clients impacted by the network problem and transmitting fourth alarm information to the clients; and
invoking a display method, the display method transmitting display information that causes a device to display the network problem.

19. A method of processing information as set forth in claim 18, wherein the second alarm information, the third alarm information, and the fourth alarm information are relevant information.

20. A method of processing information as set forth in claim 18, wherein the follow-me method, the alarm method, the impact method, the management method, the client method and the display method are performed with a server.
